(19) United States
(12) Patent Application Publication
(10) Pub. No.: US 2006/0217825 A1
(43) Pub. Date: Sep. 28, 2006

(54) Electronic apparatus and data processing method

(75) Inventors: Naoko Takeda, Tokyo (JP); Yoshinori Ando, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/368,597

(22) Filed: Mar. 7, 2006

(30) Foreign Application Priority Data
Mar. 14, 2005 (JP) 2005-071673

(51) Int. Cl. G06F 19/00; G10F 5/00

(52) U.S. Cl. 700/90; 84/453

(57) ABSTRACT

An electronic apparatus having an acceleration sensor for detecting acceleration occurring in the electronic apparatus, a housing for housing the acceleration sensor, a jolt detector housed in the housing and detecting whether or not the housing is jolted based on the detection result of the acceleration sensor, a processor for processing relating to content data, and a controller for controlling the processor when a jolt of the housing is detected by the jolt detector.

### CROSS REFERENCES TO RELATED APPLICATIONS

The present invention contains subject matter related to Japanese Patent Application No. 2005-071673 filed in the Japan Patent Office on Mar. 14, 2005, the entire contents of which being incorporated herein by reference.

### BACKGROUND OF THE INVENTION

1. Field of the Invention

The present invention relates to electronic apparatus and a data processing method based on detection results of an acceleration sensor.

2. Description of the Related Art

For example, a portable music player selects music data of identification data indicated by previously held favorite list data in for example a shuffle mode with a high priority. The portable music player adds identification data of music data designated by a user to the favorite list data by for example user button operation. Further, the portable music player displays an operation screen for prompting the user to search for and select the music data to be played back, deleted, etc. Conventionally, the operation screen has been switched and the cursor moved on the operation screen in response to user button operation. For more details, see Japanese Patent Publication (A) No. 2005-11474

In such a portable music player, however, there is a limit to the number of operation buttons due to its size. On the other hand, a portable music player is provided with a variety of functions. For this reason, in a conventional portable music player, the user often operates the same button several times to designate a predetermined function. For this reason, there is the inconvenience that the operation is troublesome. The same inconvenience occurs in electronic apparatus other than portable music players.

### SUMMARY OF THE INVENTION

To overcome the disadvantage of the related art, it is desirable to provide electronic apparatus and a data processing method able to improve the operation property of electronic apparatus.

According to a first aspect of the invention, there is provided electronic apparatus having an acceleration sensor for detecting acceleration occurring in the electronic apparatus, a housing for housing the acceleration sensor, a jolt detecting means housed in the housing and detecting whether or not the housing is jolted based on the detection result of the acceleration sensor, a processing means for processing relating to content data, and a control means for controlling the processing means when a jolt of the housing is detected by the jolt detecting means.

Preferably, a storage medium, a head for accessing the storage medium, and a drop detecting means for detecting dropping of the electronic apparatus based on detection results of the acceleration sensor are provided in the housing; the processing means processes the content data which the head reads from the storage medium; and the control means moves the head to a predetermined retraction position when the drop detecting means detects dropping of the electronic apparatus.

Preferably, the acceleration sensor generates a detection signal in accordance with acceleration in a direction substantially perpendicular to a predetermined surface among a plurality of surfaces forming the housing, and the control means controls the processing means when the jolt detecting means detects a pulse in the detection signal generated by the acceleration sensor.

More preferably, the control means controls the processing means when the jolt detecting means detects continuous change in any of the X-, Y-, and Z-detection signals, then detects the generation of the pulse in the Z-detection signal, then detects continuous change in any of the X-, Y-, and Z-detection signals.

Alternatively, the control means controls the processing means when the jolt detecting means does not detect a change in any of the X-, Y-, and Z-detection signals, then, in that state, detects the generation of the pulse in the Z-detection signal, then does not detect a change in any of the X-, Y-, and Z-detection signals.

More preferably, the acceleration sensor generating a Z-detection signal indicating acceleration in a Z-direction constituting the perpendicular direction and an X-detection signal and Y-detection signal indicating accelerations in mutual perpendicular X- and Y-directions perpendicular to the Z-direction, and the control means does not control the processing means when the jolt detecting means detects continuous change in any of the X-, Y-, and Z-detection signals, then detects the generation of the pulse in the Z-detection signal, then does not detect a change in any of the X-, Y-, and Z-detection signals.

More preferably, the control means control means performs control for moving the head to a retracted position with priority over control of the processing means when detection of a jolt of the housing by the jolt detecting means and detection of dropping of the electronic apparatus by the drop detecting means compete.

Preferably, the apparatus further is provided with a storage medium storing the content data, the apparatus further has a memory storing skip list data showing identification data of the content data designated to be skipped in the content data stored on the storage medium, and the control means adds identification data of the content data being played back to the skip list when the jolt detecting means detects a jolt of the housing while the processing means is playing back the content data.

More preferably, the control means makes the processing means perform processing for playback of content data corresponding to identification data other than identification data shown by the skip list stored in the memory in a predetermined operation mode and adds identification data of the content data being played back to the skip list when a jolt of the housing is detected by the jolt detecting means.

Preferably, the apparatus further has a memory storing favorite list data showing identification data of favorite content data of a user in content data stored in the storage medium, and the control means add identification data of the content data being played back to the favorite list data when the processing means is playing back the content data and the swing detecting means detects the rocking in a predetermined rocking direction.

More preferably, the apparatus further has swing detecting means for detecting rocking of the electronic apparatus and a rocking direction, and the control means makes the processing means perform processing for playback of the content data corresponding to the identification data shown by the favorite list data stored in the memory with priority and adds identification data of the content data being played back to the favorite list data when the swing detecting means detects the rocking in a predetermined rocking direction while the processing means is playing back content data.

Preferably, the electronic apparatus further has a swing detecting means for detecting rocking of the electronic apparatus and a rocking direction, and the control means performs processing for moving the cursor on the operation screen or switching the operation screen when the swing detecting means detects the rocking in a predetermined rocking direction during display of an operation screen on a display.

Preferably, the electronic apparatus further has a memory storing first list data showing identification data of the content data having a first attribute and second list data showing identification data of the content data having a second attribute in content data stored in the storage medium and a swing detecting means for detecting a speed of rocking by the electronic apparatus, and the control means makes the processing means perform processing for playing back content data of identification data shown by the first list data when the swing detecting means detects rocking of a speed of a predetermined threshold value or more and makes the processing means perform processing for playing back content data of identification data shown by the second list data when the swing detecting means detects rocking of a speed less than a predetermined threshold value.

According to a second aspect of the invention, there is provided a data processing method run in electronic apparatus playing back content data, comprising a first step of using acceleration detected by an acceleration sensor housed in a housing of the electronic apparatus to detect if the housing has been jolted and a second step of performing predetermined processing relating to the content data when detecting that the housing has been jolted at the first step.

According to the present invention, electronic apparatus and a data processing method able to improve the operation property of electronic apparatus can be provided.

### BRIEF DESCRIPTION OF THE DRAWINGS

These and other objects and features of the present invention will become clearer from the following description of the preferred embodiments given with reference to the attached drawings, wherein:

FIG. 1 is a view of the overall configuration of a portable music player according to an embodiment of the present invention;

FIG. 2 is a flow chart for explaining relationships among access processing, a drop detection processing, and jolt detection processing for a storage disk of the portable music player shown in FIG. 1;

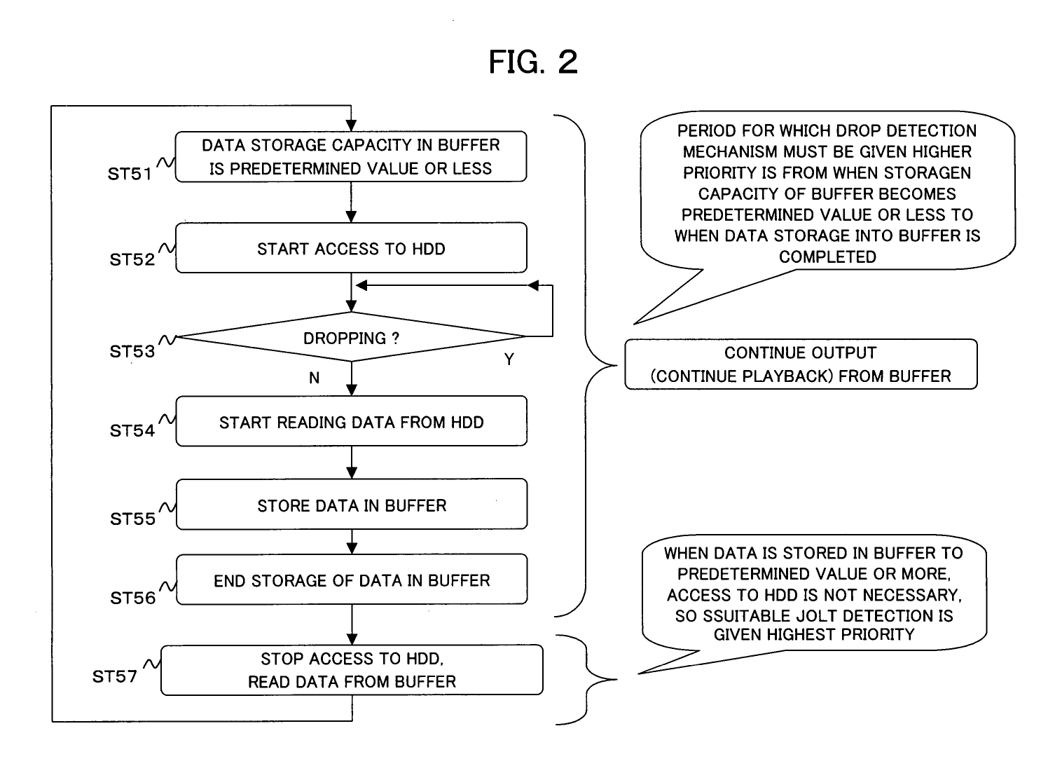

FIGS. 3A and 3B are schematic views of the portable music player shown in FIG. 1;

FIG. 4 is a view for explaining the jolt detection processing by a jolt detector shown in FIG. 1;

FIG. 5 is a waveform diagram of an acceleration signal when a user jolts the portable music player while holding it by his hand;

FIG. 6 is a waveform diagram of the acceleration signal when the user jolts the portable music player in a state where he places it on a stand;

FIG. 7 is a waveform diagram of the acceleration signal when the user places the portable music player on a stand from a holding state;

FIG. 8 is a flow chart for explaining an example of operation where the portable music player is swung or jolted against by the user during the display of a playback screen on a display shown in FIG. 3;

FIG. 9 is a flow chart for explaining an example of the operation where the portable music player 1 is swung in a Y-direction by the user during the display of a tune selection screen on the display shown in FIG. 3;

FIG. 10 is a flow chart for explaining an example of operation where the portable music player is rotated by the user during the display of a screen other than the playback screen on the display shown in FIG. 3; and

FIG. 11 is a flow chart for explaining an example of the operation where the portable music player 1 is swung by the user with a predetermined speed during the display of the playback screen on the display shown in FIG. 3.

### DESCRIPTION OF THE PREFERRED EMBODIMENTS

Below, a portable music player according to an embodiment of the present invention will be explained.

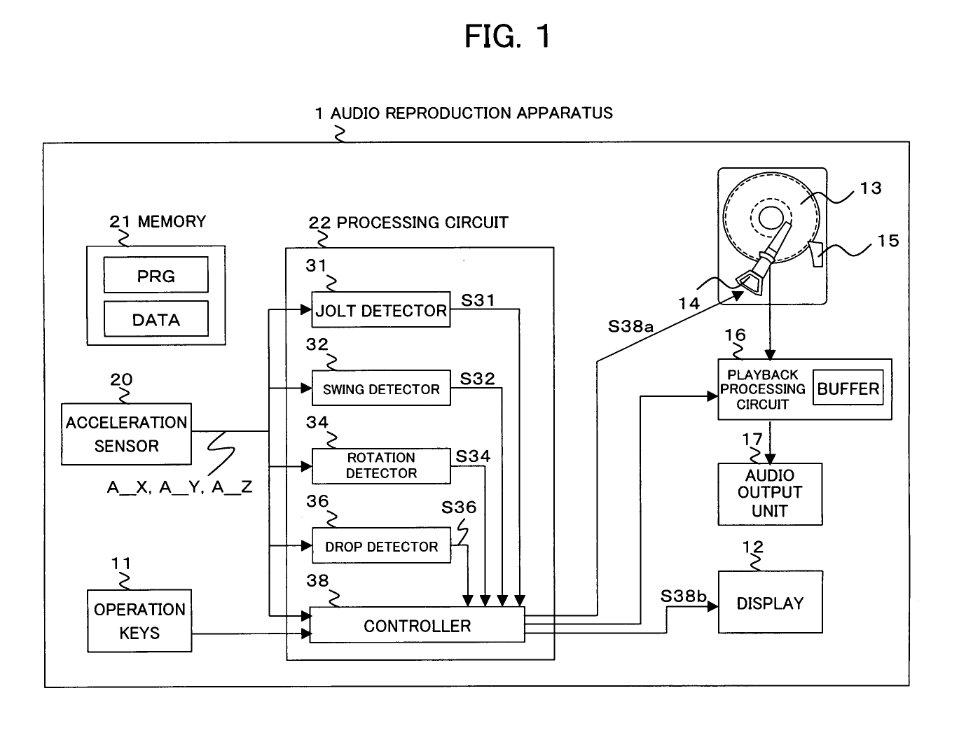

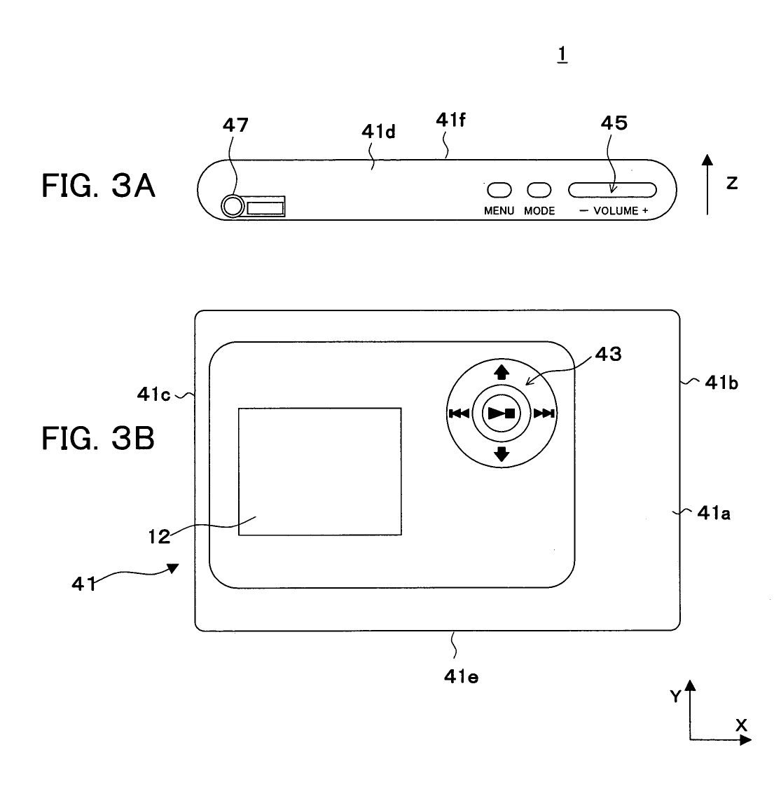

First, an explanation will be given of the correspondence between components of the present embodiment and components of the invention as summarized above. A portable music player 1 corresponds to the electronic apparatus of the present invention. An acceleration sensor 20 shown in FIG. 1 corresponds to the acceleration sensor of the present invention, a housing 41 shown in FIG. 3 corresponds to the housing of the present invention, a jolt detector 31 corresponds to the jolt detecting means of the present invention, a controller 38 corresponds to the control means of the present invention, and a playback processing circuit 16 corresponds to the processing means of the present invention. A storage disk 13 shown in FIG. 13 corresponds to the storage medium of the present invention, a head 14 corresponds to the head of the present invention, and a drop detector 36 corresponds to the drop detecting means.

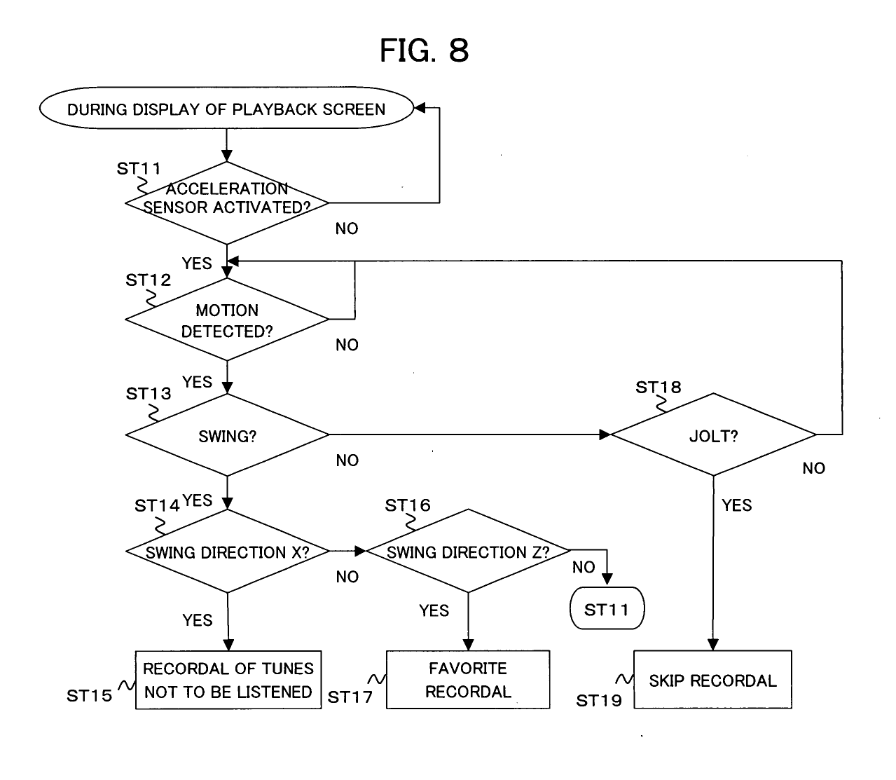

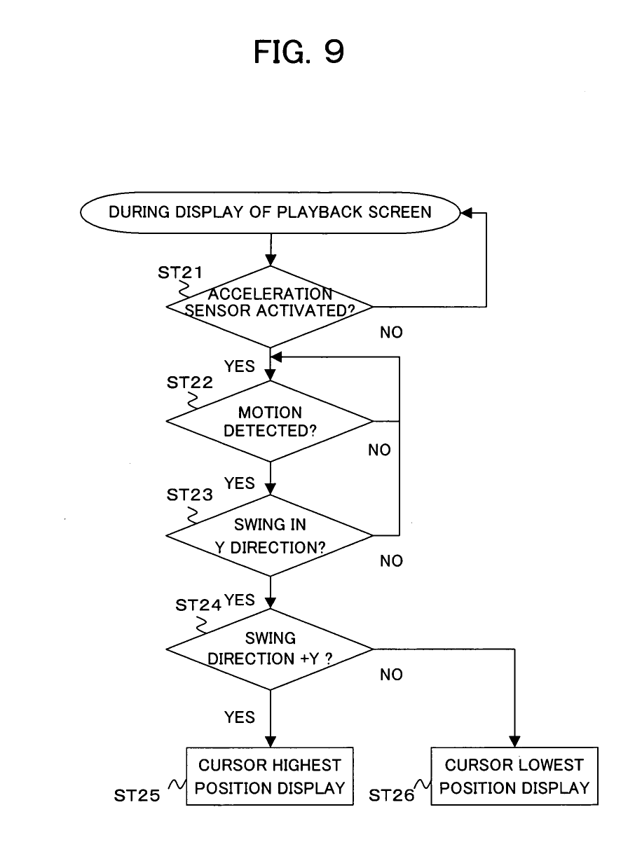

Step ST18 shown in FIG. 8 corresponds to the first step of the second aspect of the invention, and step ST19 corresponds to the second step. Steps ST23 and ST24 shown in FIG. 9 correspond to the first step of the third aspect of the invention, and steps ST25 and sT26 correspond to the second step. A program PRG shown in FIG. 1 corresponds to the program of the present invention.

FIG. 1 is a view of the overall configuration of the portable music player 1 according to the embodiment of the present invention. As shown in FIG. 1, the portable music player 1 has operation keys 11, a display 12, a storage disk 13, a head 14, a playback processing circuit 16, an audio output unit 17, an acceleration sensor 20, a memory 21, and a processing circuit 22. Components of the portable music player 1 shown in FIG. 1 are stored in a thin-walled housing 41 as shown in FIGS. 3A and 3B.

The operation keys 11 are provided on for example different surfaces of the housing 41 of the portable music player 1 as shown in FIGS. 3A and 3B. The operation keys 11 include for example a cross key 43 provided on the front surface 41a of the housing 41 and a volume key 45, a menu key (MENU), and a mode key (MODE) provided on a side surface 41d. The operation keys 11 output operation signals in response to operation by the user to the controller 38 of the processing circuit 22 shown in FIG. 1.

The display 12 displays a screen in response to a display signal S38b from the processing circuit 22. The screens include a tune selection screen for selecting content (music data etc.) for playback, a playback screen, a menu screen, and other operation screens.

The storage disk 13 is a storage medium such as a hard disk. The storage disk 13 stores content data such as music data.

The head 14 reads out the content data from the storage disk 13 and outputs it to the playback processing circuit 16.

The head 14 moves from a head retraction part 15 toward the storage disk 13 when accessing the storage disk 13. The head 14 is held in the head retraction part 15 in a state when not accessing the storage disk 13. The head retraction part 15 holds the head 14 so that even if a shock is given to the portable music player 1, the storage area of the storage disk 13 is not damaged. The head 14 reads out the music data from a designated address on the storage disk 13 based on the control signal S38a from the controller 38 and outputs it to the playback processing circuit 16.

The playback processing circuit 16 performs playback processing of the content data read out from the storage disk 13 by the head 14 and outputs a playback signal to an audio output unit 17. The playback processing circuit 16 is provided with a buffer memory BUF and stores the content data previously read from the storage disk 13 in the buffer memory BUF. Then, the playback processing circuit 16 reads out the content data from the buffer memory BUF and performs the playback processing. Specifically, the playback processing circuit 16 starts the access to the storage disk 13 by using the head 14 (step ST52) when the remaining amount of the content data stored in the buffer memory BUF becomes a predetermined value or less (step ST51). Then, the playback processing circuit 16 starts the read operation of the content data from the storage disk 13 (step ST54) under the condition that the drop detector 36 does not detect dropping (step ST53) as will be explained later. Due to this, the content data read from the storage disk 13 is stored in the buffer memory BUF (step ST55). When a predetermined amount of the content data is stored, the playback processing circuit 16 ends the read operation from the storage disk 13 (step ST56). In the portable music player 1, during the period of steps ST51 to ST56, drop detection is given a higher priority than jolt detection. Then, the playback processing circuit 16 stops the read operation from the storage disk 13 and performs the playback processing of the content data read from the buffer memory BUF (step ST57). In the portable music player 1, jolt detection is given a higher priority during the period of step ST57.

The audio output unit 17 amplifies the playback signal and outputs it from a headphone terminal 47 shown in FIG. 3 to a headphone.

The acceleration sensor 20 detects the accelerations in X-, Y-, and Z-directions as shown in FIG. 3 and outputs an acceleration signal A_X indicating the acceleration in an X-direction, an acceleration signal A_Y indicating the acceleration in a Y-direction, and an acceleration signal A_Z indicating the acceleration in a Z-direction to the processing circuit 22.

The memory 21 stores the program PRG defining the processing of the processing circuit 22 and a variety of data DATA used for the processing of the processing circuit 22.

The processing circuit 22 runs the program PRG read from the memory 21 and controls the operation of the portable music player 1. As shown in FIG. 1, the processing circuit 22 has a jolt detector 31, a swing detector 32, a rotation detector 34, a drop detector 36, and a controller 38. Elements of the processing circuit 22 may be realized as individual electronic circuits or realized by running a program PRG read from the memory 21 by a central processing unit (CPU).

Jolt Detector 31

The jolt detector 31 detects whether or not the front surface 41a, back surface 41f, and side surfaces 41b, 41c, 41d, and 41e of the housing 41 shown in FIG. 3 are jolted by the fingers or the like by the user based on the acceleration signals A_X, A_Y, and A_Z input from the acceleration sensor 20.

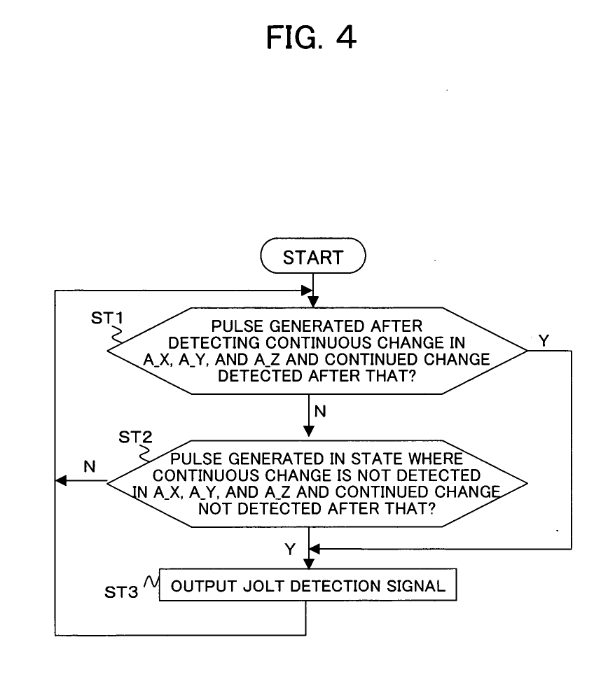

FIG. 4 is a view for explaining the jolt detection processing by the jolt detector 31 shown in FIG. 1. Below, an explanation will be given of the steps of FIG. 4.

Step ST1

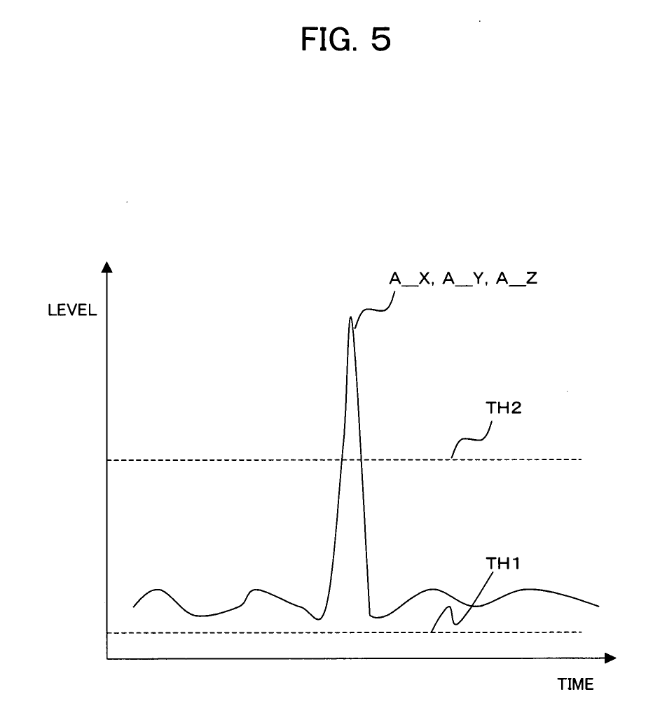

The jolt detector 31 monitors the acceleration signals A_X, A_Y, and A_Z input from the acceleration sensor 20 and judges whether the condition is satisfied of a continuous change exceeding a threshold value TH1 shown in FIG. 5 occurring in the level of any of these signals, then a pulse exceeding a threshold value TH2 being generated, then a continuous change exceeding the threshold value TH1 occurring. The condition is satisfied when for example the level of at least one of the acceleration signals A_X, A_Y, and A_Z exhibits the waveform shown in FIG. 5. Note that the continuous change of the acceleration signals A_X, A_Y, and A_Z exceeding the threshold value TH1 does not have to exceed the threshold value TH1 all the time. Also, the above condition at step ST1 is satisfied when the housing 41 is jolted by the fingers or the like while the portable music player 1 is held by the user. The jolt detector 31 proceeds to step ST3 when judging that the above condition is satisfied, while proceeds to step ST2 when not judging so.

Step ST2

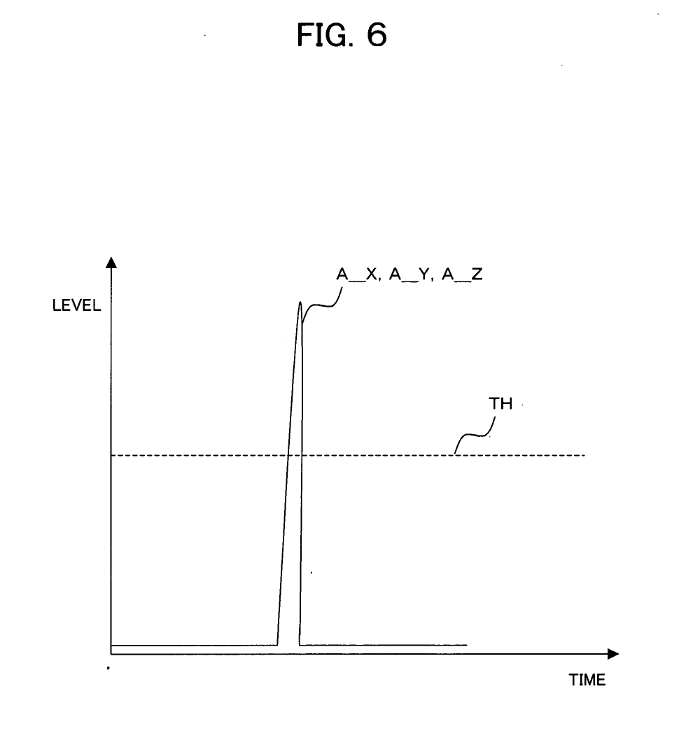

The jolt detector 31 monitors the acceleration signals A_X, A_Y, and A_Z input from the acceleration sensor 20 and judges whether the condition is satisfied of the state of the levels of all of these signals being the threshold value TH1 or less shown in FIG. 6 (state where almost no change is detected) being held, then a pulse exceeding the threshold value TH2 in at least one of the signals being generated, then the state of the levels of all of these signals being the threshold value TH1 or less again being held. The condition is satisfied when the level of at least one of the acceleration signals A_X, A_Y, and A_Z exhibits the waveform shown in FIG. 6. Note that the above condition is satisfied at step ST2 when the housing 41 is jolted by the fingers or the like in a state where the portable music player 1 is placed on a stand etc. The jolt detector 31 proceeds to step ST3 when judging that the above condition is satisfied, while returns to step ST1 when not judging so.

Step ST3

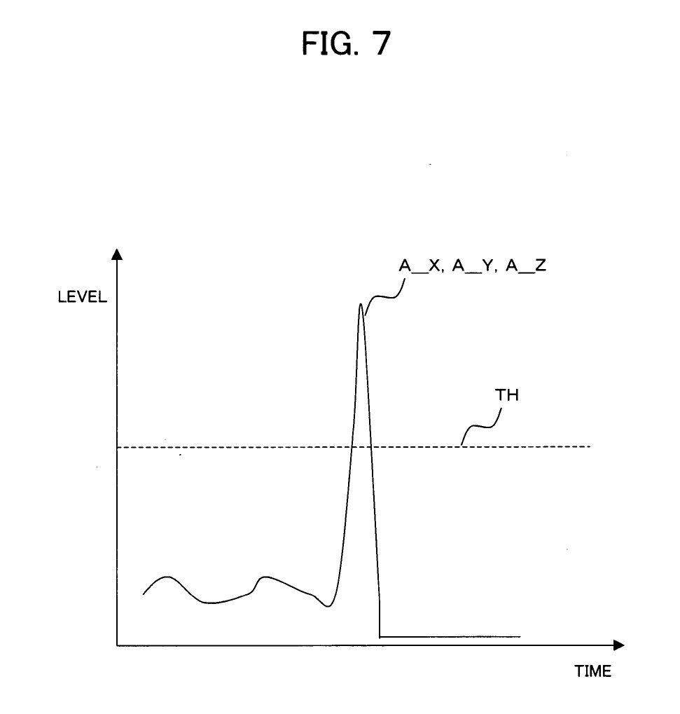

The jolt detector 31 outputs a jolt detection signal S31 to the controller 38 shown in FIG. 1. The jolt detector 31 does not erroneously detect shock occurring when the user places the portable music player 1 on the stand or the like as a jolt since it judges whether or not the housing 41 of the portable music player 1 is jolted by the user at steps ST1 and ST2 shown in FIG. 4 explained above. Namely, when the portable music player 1 is placed on the stand etc., the acceleration signals A_X, A_Y, and A_Z exhibit for example the waveforms shown in FIG. 7. In this case, the jolt detector 31 judges that the above condition of step ST2 is not satisfied at step ST2 after passing through step ST1 shown in FIG. 4, then returns to step ST1.

Note that in the example explained by using FIG. 4, since the judgment is made based on whether or not a pulse exceeding the threshold value TH2 is generated in any of the acceleration signals A_X, A_Y, and A_Z, even the case of any of the front surface 41a, back surface 41f, and side surfaces 41b, 41c, and 41d shown in FIGS. 3A and 3B being jolted by the fingers or the like is detected as a valid pulse. As another example, the jolt detector 31 may detect in which acceleration signal among the acceleration signals A_X, A_Y, and A_Z the pulse was generated and output information specifying the acceleration signal at which the pulse was generated as a jolt detection signal S31 to the controller 38. Due to this, the controller 38 can perform processing previously linked with the surface jolted by the user among the different surfaces of the housing 41 based on the acceleration signal at which the pulse was generated.

Swing Detector 32

The swing detector 32 judges whether or not the portable music player 1 was swung by the user based on the acceleration signals A_X, A_Y, and A_Z input from the acceleration sensor 20 and outputs a swing detection signal S32 to the controller 38 shown in FIG. 1 when judging that the portable music player 1 was swung. The swing detector 32 judges as swinging for example the case where at least one of the acceleration signals A_X, A_Y, and A_Z or a composite signal of the acceleration signals A_X, A_Y, and A_Z exceeds a predetermined threshold value by a predetermined pattern. Note that the swing detector 32 may also generate a swing detection signal S32 indicating the direction in which the portable music player 1 is swung based on the acceleration signals A_X, A_Y, and A_Z.

Rotation Detector 34

The rotation detector 34 judges whether or not the portable music player 1 is rotated by the user based on the acceleration signals A_X, A_Y, and A_Z input from the acceleration sensor 20 and outputs a rotation detection signal S34 to the controller 38 when judging it was rotated. The rotation detector 34 detects the rotation based on for example a combination of the acceleration signals A_X, A_Y, and A_Z or the composite signal of the acceleration signals A_X, A_Y, and A_Z.

Drop Detector 36

The drop detector 36 judges whether or not the portable music player 1 was dropped based on the acceleration signals A_X, A_Y, and A_Z input from the acceleration sensor 20 and outputs a drop detection signal S36 to the controller 38 shown in FIG. 1 when judging it was dropped. The drop detector 36 detects dropping when the composite signal of the acceleration signals A_X, A_Y, and A_Z indicates “0” in the case for example where the acceleration sensor 20 is located at the center of gravity of the portable music player 1.

Controller 38

The controller 38 performs predetermined processing based on the operation signals input from the operation keys 11. Further, the controller 38 performs processing such as control of the operation screen displayed on the display 12, control of reading of the music data from the storage disk 13 by the head 14, and processing for updating the data DATA stored in the memory 21 based on the jolt detection signal S31 input from the jolt detector 31, the swing detection signal S32 input from the swing detector 32, and the rotation detection signal S34 input from the rotation detector 34. Further, when receiving as input the drop detection signal S36 from the drop detector 36, the controller 38 retracts the head 14 to the head retraction part 15. Further, when simultaneously receiving as input the detection signals from the jolt detector 31, the swing detector 32, and the rotation detector 34 and the drop detection signal S36 from the drop detector 36, the controller 38 retracts the head 14 based on the drop detection signal S36 with a higher priority.

Below, an example of the operation of the portable music player 1 will be explained in relation to the processing of the controller 38.

First Example of Operation

In this example of operation, the case where the portable music player 1 is swung or jolted by the user during the display of the playback screen on the display 12 shown in FIG. 3B will be explained. FIG. 8 is a flow chart for explaining the first example of operation of the portable music player 1 shown in FIG. 1. The controller 38 performs the following processing during the display of the playback screen on the display 12.

Step ST11

The controller 38 shown in FIG. 1 judges whether or not the acceleration sensor 20 is activated. Specifically, when activation of the acceleration sensor 20 can be set by the operation of the user, the controller 38 checks the settings and judges whether or not the acceleration sensor 20 is activated.

Step ST12

The controller 38 judges whether or not motion (rocking) of the portable music player 1 is detected based on the acceleration signals A_X, A_Y, and A_Z from the acceleration sensor 20. The controller 38 proceeds to step ST13 when judging that motion is detected, while repeats the processing of step ST12 when not judging so.

Step ST13

The controller 38 judges whether or not a swing detection signal S32 is input from the swing detector 32, proceeds to step ST14 when judging the input, while proceeds to step ST18 when not judging so.

Step ST14

The controller 38 judges whether or not the above swing is swing in the X-direction based on the acceleration signals A_X, A_Y, and A_Z from the acceleration sensor 20, proceeds to step ST15 when judging that swing occurs in the X-direction, while proceeds to step ST16 when not judging

Step ST15

The controller 38 records identification data of the music data being played back at present at the playback processing circuit 16 to the list of tunes not to be listened to stored in the memory 21. When the user designates the shuffle playback mode, the controller 38 sets the degree of priority for playback lower for content data having identification data recorded in the list of tunes not to be listened to among the music data stored in the storage disk 13 lower compared with other content data.

Step ST16

The controller 38 judges whether or not the above swing is swing in the Z-direction based on the acceleration signals A_X, A_Y, and A_Z from the acceleration sensor 20, proceeds to step ST17 when judging the swing occurs in the Z-direction (for example, the operation of inclining the portable music player 1 toward the front of the user in the state of holding it), while returns to step ST11 when not judging so.

Step ST17

The controller 38 records identification data of the music data being played back at present at the playback processing circuit 16 in a list of favorites stored in the memory 21. When the user designates the shuffle playback mode, the controller 38 plays back the content data having the identification data recorded in the list of favorites with a higher priority among the music data stored in the storage disk 13.

Step ST18

The controller 38 judges whether or not the jolt detection signal S31 is input from the jolt detector 31, proceeds to step ST19 when judging the input, while returns to step ST11 when not judging so.

Step ST19

The controller 38 records the identification data of the music data being played back at present at the playback processing circuit 16 to a skip list stored in the memory 21.

When the user designates the shuffle playback mode, the controller 38 does not play back content data having identification data recorded in the skip list among the music data stored in the storage disk 13.

Second Example of Operation

In this example of operation, the case where the portable music player 1 is swung in the Y-direction during the display of the tune selection screen on the display 12 shown in FIG. 3 will be explained. FIG. 9 is a flow chart for explaining the second example of operation of the portable music player 1 shown in FIG. 1. The controller 38 performs the following processing during the display of the tune selection screen on the display 12.

Step ST21

The controller 38 shown in FIG. 1 judges whether or not the acceleration sensor 20 is activated. Specifically, the controller 38 checks the settings when activation of the acceleration sensor 20 can be set by the operation of the user and judges whether or not the acceleration sensor 20 is activated.

Step ST22

The controller 38 judges whether or not motion (rocking) of the portable music player 1 is detected based on the acceleration signals A_X, A_Y, and A_Z from the acceleration sensor 20. The controller 38 proceeds to step ST23 when judging that the motion is detected, while repeats the processing of step ST22 when not judging so.

Step ST23

The swing detector 32 judges whether or not the portable music player 1 is swung in the Y-direction based on the acceleration signal A_Y and proceeds to step ST24 when judging that the portable music player 1 is swung in the Y-direction.

Step ST24

The swing detector 32 judges in which direction between a +Y direction and a −Y direction the portable music player 1 was swung based on the acceleration signal A_Y and outputs the judgment result signal to the controller 38. The controller 38 proceeds to step ST25 when judging that the portable music player 1 was swung in the +Y direction based on the judgment result signal, while proceeds to step ST25 when judging that the portable music player 1 was swung in the −Y direction.

Step ST25

The controller 38 generates a display signal S38b for moving the cursor to the highest position on the tune selection screen being displayed and outputs this to the display 12.

Step ST26

The controller 38 generates a display signal S38b for moving the cursor to the highest position on the tune selection screen being displayed and outputs this to the display 12.

Third Example of Operation

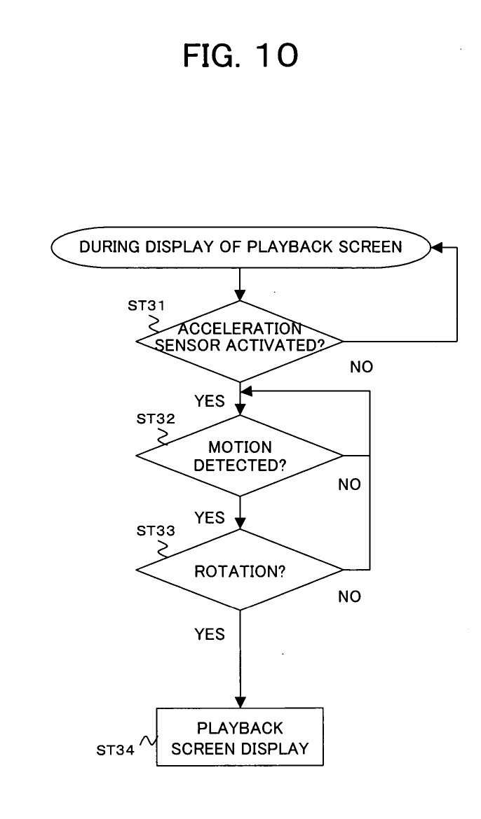

In this example of operation, a case where the portable music player 1 is rotated by the user during the display of a screen other than the playback screen on the display 12 shown in FIG. 3 will be explained. FIG. 10 is a flow chart for explaining a third example of operation of the portable music player 1 shown in FIG. 1. The controller 38 performs the following processing during the display of a screen other than the playback screen on the display 12.

Step ST31

The controller 38 shown in FIG. 1 judges whether or not the acceleration sensor 20 is activated. Specifically, when activation of the acceleration sensor 20 can be set by the operation of the user, the controller 38 checks the setting and judges whether or not the acceleration sensor 20 is activated.

Step ST32

The controller 38 judges whether or not motion (rocking) of the portable music player 1 is detected based on the acceleration signals A_X, A_Y, and A_Z from the acceleration sensor 20. The controller 38 proceeds to step ST33 when judging that the motion is detected, while repeats the processing of step ST32 when not judging so.

Step ST33

The swing detector 32 judges whether or not the rotation detection signal S34 is input from the rotation detector 34 and proceeds to step ST34 when judging the input.

Step ST34

The controller 38 generates a display signal S38b for displaying the playback screen and outputs this to the display 12. Due to this, the display of the display 12 is switched from a screen other than the playback screen to the playback screen.

Fourth Example of Operation

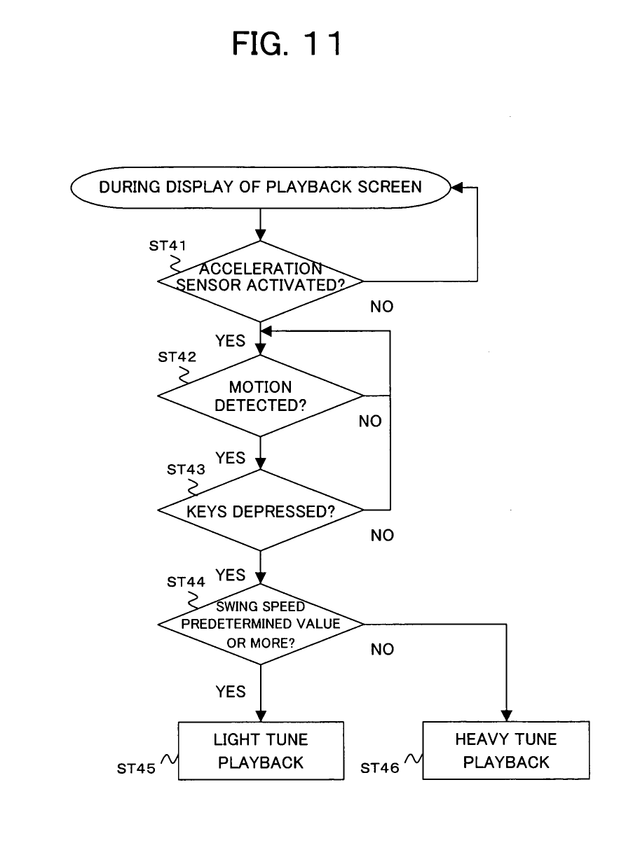

In this example of operation, a case where the portable music player 1 is swung by the user at a predetermined speed during the display of the playback screen on the display 12 shown in FIG. 3 will be explained. FIG. 11 is a flow chart explaining the fourth example of operation of the portable music player 1 shown in FIG. 1. The controller 38 performs the following processing during the display of the playback screen on the display 12.

Step ST41

The controller 38 shown in FIG. 1 judges whether or not the acceleration sensor 20 is activated. Specifically, when the activation of the acceleration sensor 20 can be set by the operation of the user, the controller 38 checks the setting and judges whether or not the acceleration sensor 20 is activated.

Step ST42

The controller 38 judges whether or not motion (rocking) of the portable music player 1 is detected based on the acceleration signals A_X, A_Y, and A_Z from the acceleration sensor 20. The controller 38 proceeds to step ST43 when judging that motion is detected, while repeats the processing of step ST42 when not judging so.

Step ST43

The controller 38 judges whether or not the operation keys 11 have been operated based on the operation signal from the operation key 11, proceeds to step ST44 when judging that it is operated, while returns to step S42 when not judging so.

Step ST44

The swing detector 32 judges whether or not the speed of swing of the portable music player 1 is the predetermined threshold value or more based on the acceleration signals A_X, A_Y, and A_Z from the acceleration sensor 20, proceeds to step ST45 when judging that the speed of the swing is the threshold value or more, while proceeds to step ST46 when not judging so.

Step ST45

The controller 38 outputs a control signal S38a instructing for example the selection of the identification data of the music data from a light tune list (first list data of the present invention) stored in the memory 21 and the reading of that from the storage disk 13 to the head 14. Due to this, music data constituting a light tune is played back in the playback processing circuit 16.

Step ST46

The controller 38 outputs the control signal S38a instructing for example the selection of the identification data of the music data from a heavy tune list (second list data of the present invention) stored in the memory 21 and the reading of that from the storage disk 13 to the head 14. Due to this, the music data constituting a heavy tune is played back in the playback processing circuit 16.

As explained above, according to the portable music player 1, the processing for automatically detecting a jolt operation of the housing 41 of the portable music player 1 and a swing operation and rotation operation of the portable music player 1 by the user and previously assigning the same to the related operation is automatically executed. Due to this, the user of the portable music player 1 is freed from troublesome key operation, thus the operation property of the portable music player 1 is improved.

The present invention is not limited to the above embodiment. In the above embodiment, as the electronic apparatus of the present invention, the portable music player 1 was exemplified, but the type of the electronic apparatus is not particularly limited so far as it mounts an acceleration sensor, then performs processing in response to an outside instruction. As the electronic apparatus of the present invention, other than a portable music player, a mobile phone, portable and stationary video cassette deck etc. may be used. Further, the controller 38 may also perform the processing previously assigned for several jolts when the jolt detection signal S31 is input from the jolt detector 31 several times within a predetermined time. Further, in the above embodiment, the case where the operation of the operation keys 11 and the detection results of the swing detector 32 were combined and used as the input instruction was exemplified, but the operation of the operation keys 11 and the jolt detection signal S31 may be combined and used as the input instruction as well.

The present invention can be applied to an electronic apparatus system for performing the processing based on the detection results of the acceleration sensor.

It should be understood by those skilled in the art that various modifications, combinations, sub-combinations and alterations may occur depending on design requirements and other factors insofar as they are within the scope of the appended claims or the equivalents thereof.

What we claim is:

1. An electronic apparatus comprising:
an acceleration sensor for detecting acceleration occurring in said electronic apparatus,
a housing for housing said acceleration sensor,
a jolt detecting means housed in said housing and detecting whether or not said housing is jolted based on the detection result of said acceleration sensor,
a processing means for processing relating to content data, and
a control means for controlling said processing means when a jolt of said housing is detected by said jolt detecting means.

2. An electronic apparatus as set forth in claim 1, wherein
a storage medium,
a head for accessing said storage medium, and
a drop detecting means for detecting dropping of said electronic apparatus based on detection results of said acceleration sensor are provided in said housing;
said processing means processes said content data which said head reads from said storage medium; and
said control means moves said head to a predetermined retraction position when said drop detecting means detects dropping of said electronic apparatus.

3. An electronic apparatus as set forth in claim 1, wherein
said acceleration sensor generates a detection signal in accordance with acceleration in a direction substantially perpendicular to a predetermined surface among a plurality of surfaces forming said housing, and
said control means controls said processing means when said jolt detecting means detects a pulse in said detection signal generated by said acceleration sensor.

4. An electronic apparatus as set forth in claim 3, wherein said control means controls said processing means when said jolt detecting means detects continuous change in any of said X-, Y-, and Z-detection signals, then detects the generation of said pulse in said Z-detection signal, then detects continuous change in any of said X-, Y-, and Z-detection signals.

5. An electronic apparatus as set forth in claim 3, wherein said control means controls said processing means when said jolt detecting means does not detect a change in any of said X-, Y-, and Z-detection signals, then, in that state, detects the generation of said pulse in said Z-detection signal, then does not detect a change in any of said X-, Y-, and Z-detection signals.

6. An electronic apparatus as set forth in claim 3, wherein
said acceleration sensor generating a Z-detection signal indicating acceleration in a Z-direction constituting said perpendicular direction and an X-detection signal and Y-detection signal indicating accelerations in mutual perpendicular X- and Y-directions perpendicular to said Z-direction, and
said control means does not control said processing means when said jolt detecting means detects continuous change in any of said X-, Y-, and Z-detection signals, then detects the generation of said pulse in said Z-detection signal, then does not detect a change in any of said X-, Y-, and Z-detection signals.

7. An electronic apparatus as set forth in claim 2, wherein said control means control means performs control for moving said head to a retracted position with priority over control of said processing means when detection of a jolt of said housing by said jolt detecting means and detection of dropping of said electronic apparatus by said drop detecting means compete.

8. An electronic apparatus as set forth in claim 1, wherein
said apparatus further comprises a storage medium storing said content data,
said apparatus further has a memory storing skip list data showing identification data of said content data designated to be skipped in the content data stored on said storage medium, and
said control means adds identification data of said content data being played back to said skip list when said jolt detecting means detects a jolt of said housing while said processing means is playing back the content data.

9. An electronic apparatus as set forth in claim 8, wherein said control means makes said processing means perform processing for playback of content data corresponding to identification data other than identification data shown by said skip list stored in said memory in a predetermined operation mode and adds identification data of said content data being played back to said skip list when a jolt of said housing is detected by said jolt detecting means.

10. An electronic apparatus as set forth in claim 1, wherein
said apparatus further has a memory storing favorite list data showing identification data of favorite content data of a user in content data stored in said storage medium, and
said control means add identification data of said content data being played back to said favorite list data when said processing means is playing back said content data and said swing detecting means detects said rocking in a predetermined rocking direction.

11. An electronic apparatus as set forth in claim 10, wherein
said apparatus further has swing detecting means for detecting rocking of said electronic apparatus and a rocking direction, and
said control means makes said processing means perform processing for playback of said content data corresponding to said identification data shown by said favorite list data stored in said memory with priority and adds identification data of said content data being played back to said favorite list data when said swing detecting means detects said rocking in a predetermined rocking direction while said processing means is playing back content data.

12. An electronic apparatus as set forth in claim 1, wherein
said electronic apparatus further comprises a swing detecting means for detecting rocking of said electronic apparatus and a rocking direction, and
said control means performs processing for moving the cursor on said operation screen or switching said operation screen when said swing detecting means detects said rocking in a predetermined rocking direction during display of an operation screen on a display.

13. An electronic apparatus as set forth in claim 1, wherein
said electronic apparatus further comprises
a memory storing first list data showing identification data of said content data having a first attribute and second list data showing identification data of said content data having a second attribute in content data stored in said storage medium and
a swing detecting means for detecting a speed of rocking by said electronic apparatus, and
said control means makes said processing means perform processing for playing back content data of identification data shown by said first list data when said swing detecting means detects rocking of a speed of a predetermined threshold value or more and makes said processing means perform processing for playing back content data of identification data shown by said second list data when said swing detecting means detects rocking of a speed less than a predetermined threshold value.

14. A data processing method run in electronic apparatus playing back content data, comprising
a first step of using acceleration detected by an acceleration sensor housed in a housing of said electronic apparatus to detect if said housing has been jolted and
a second step of performing predetermined processing relating to said content data when detecting that said housing has been jolted at said first step.
